(19) United States
(12) Patent Application Publication
(10) Pub. No.: US 2021/0148942 A1
(43) Pub. Date: May 20, 2021

(54) METHOD OF HANDLING AT LEAST ONE PATHOLOGIC SECIMEN

(71) Applicant: INVEOX GMBH, Garching bei München (DE)

(72) Inventors: Maria SIEVERT, München (DE); Dominik SIEVERT, München (DE); Robin ZUBER, München (DE)

(21) Appl. No.: 16/623,884

(22) PCT Filed: Jun. 19, 2018
(86) PCT No.: PCT/EP2018/066308

§ 371 Date: Dec. 18, 2019

(30) Foreign Application Priority Data
Jun. 19, 2017 (EP) 17176682.7

(51) Int. Cl. G01N 35/00; B01L 3/00

(52) U.S. Cl. CPC G01N 35/00732; G01N 2035/00752; B01L 3/5453

(57) ABSTRACT

The present invention relates to a method of or for handling at least one specimen. Such a specimen can be any specimen being the result of an examination and also embraces tissue samples and/or liquid biopsies. The method can comprise the steps of: providing at least one container for the specimen, transferring at least one specimen into the container, and capturing a first data set in a first station. These method steps can be performed in any order. The further step can be a generating of a transfer sheet with accumulated data on the basis of at least the first data set. The method can also comprise the delivering of the container with the specimen and the transfer sheet to a further preparing and/or analyzing stage.

### FIELD

The present invention relates to a method of handling at least one pathologic specimen, such as biopsy specimen.

### BACKGROUND

Pathologic specimen or tissue samples need to be analyzed for various reasons. Various steps for handling such specimen(s) are known in the art.

Modern practitioners transfer a specimen or sample in general, from the original location to a center, where centralized analyses are possible, not only for the size and the quality of the instruments, but also for the qualification and experience of the analyzing specialists. Thereby, the specimen samples to be sent to the analytical laboratory should not undergo any change of their condition by autolysis, decay, decomposition and/or disintegration. In the field of food monitoring a pre-enrichment of the sample with a nutritional solution can be desired.

Nowadays, biopsy samples taken from human tissue are extracted and placed into a cavity filled with formalin. This is generally done to maintain the morphological structure of the sample specimen. The sample can then be placed into a prepared envelope and shipped to the histological laboratory for further processing, such as the section preparation, curetting, fixation and grossing etc.

Specimens received for histological examination may come from a number of different sources. They range from very large specimens or whole organs to tiny fragments of specimen. For example, the following are some of the specimen-types commonly received in a histopathology lab. Excision specimens also called surgical biopsies, where whole organs or affected areas are removed. Furthermore, incisional biopsy specimens are to be analyzed, where specimen is removed for diagnosis from within an affected area, punch biopsies, where punches are used to remove a small piece of suspicious specimen for examination, shave biopsies, where small fragments of specimen are “shaved” from a surface (usually skin), curetting, where specimen is removed in small pieces from the lining of the uterus or cervix by a curette. This is a surgical instrument for removing dead specimen, growths, etc., from the walls of certain body cavities, core biopsies, where a small specimen sample is percutaneously removed using a special needle sometimes through the skin.

Specimens are usually received in fixative or preservative but sometimes arrive untreated and must be immediately fixed. Before specimens are accepted by a laboratory, the identification or labelling and accompanying documentation will be carefully checked, all details recorded and specimen tracking commenced. It is vital that patient or research specimens are properly identified and the risk of wrong results minimized.

Fixation of the sample at the beginning of the process can be a step in preparing specimens for microscopic examination. It's objective is to prevent decay and preserve cells and specimens in an analyzable state. It does this by stopping enzyme activity, killing microorganisms and hardening the specimen while maintaining sufficient of the molecular structure to enable appropriate staining methods to be applied at the time of analysis, comprising those involving antigen-antibody reactions and those depending on preserving DNA and RNA. The sooner fixation is initiated following separation of a specimen from its blood supply the better the result can be. The most popular fixing agent is formaldehyde, usually in the form of a phosphate-buffered solution in general referred to as formalin. Ideally specimens should be fixed by immersion in formalin for six to twelve hours before they are processed.

Specimen cell structures may be stained to improve analysis results.

A further step in handling such a specimen is grossing, often referred to as cut-up, involves a careful examination and description of the specimen that will include the appearance, the number of pieces and their dimensions. Larger specimens may require further dissection to produce representative pieces from appropriate areas. For example, multiple samples may be taken from the excision margins of a tumor to ensure that the tumor has been completely removed. In the case of small specimens, the entire specimen may be processed. The specimens selected for processing will be placed in cassettes in the form of small and perforated baskets and batches will be attached onto a specimen processor for processing by wax.

Practitioners in this field have disclosed a variety of inventions. For example, WO 2014 109480 A1 discloses an embedding cassette for a biopsy, and the embedding cassette for forming, in an embedding mold, a space capable of accommodating specimen therein when the embedding cassette is coupled to the embedding mold and for embedding the specimen accommodated in the embedding mold in a state where the embedding cassette is coupled to the embedding mold, comprises: a body having a space which is connected to the accommodation space of the coupled embedding mold and in which an injected paraffin solution can be solidified when carrying out embedding work; and at least one paraffin partition groove formed on the edge of the lower surface of the body, wherein when the embedding work is carried out by being coupled to the embedding mold, the injected paraffin solution forms a partition by flowing into the at least one paraffin partition groove, thereby preventing the paraffin solution from flowing out through the embedding mold.

US 2016 153877 A1 claims a specimen handling device comprising a specimen processing cassette, which relates to a specimen processing cassette for processing small specimen specimens. The processing cassette includes a base frame and a lid frame, each including a central opening and a face adapted to abut the face of the other in registered relationship in a closed position. A porous screen spans the central opening of each of the base frame and the lid frame. The screens are spaced apart when the cassette is closed, whereby the base frame, the lid frame, and the screens define an enclosed area for holding a specimen during preparation for histological examination. The porous screen permits processing fluids to flow through the enclosure, but resists entry of particulate contaminants into the enclosure, and also resists outflow of small specimen specimens from the enclosure during processing.

U.S. Pat. No. 2,015,023 848 A1 describes a biopsy processing system designed to prevent lodging and possible loss of the specimen for analysis. The system includes a biopsy container having a longitudinal wall forming an internal compartment, a biopsy bag attached to an inner surface of the container, a cassette for receiving the biopsy bag, and an automated system for removing the biopsy bag from the biopsy container and placing the biopsy bag in the cassette.

WO 2010 090 276 A1 provides a cassette, the bottom face of which can easily be opened and closed. A cassette houses substrate. The cassette is equipped with: a cassette main body within which substrates are disposed; a cassette opening that is formed on a side of the cassette main body and through which the substrates are introduced and withdrawn; a bottom face opening formed on the bottom face of the cassette main body; a bottom plate that seals the bottom face opening; and bottom plate supports that support the bottom plate and are provided on the inner walls of the cassette main body.

WO 2013 031 421 A1 discloses an embedding tray for producing an embedding block in which a specimen is embedded in an embedding agent while the embedding block is affixed to the bottom surface of an embedding cassette, and is provided with: a bottomed cylindrical tray body that has a recessed portion in which the specimen is housed and the melted embedding agent can be poured, and has an upper surface on which the embedding cassette is mounted; and a contact body that is provided on the upper surface of the tray body and is in contact with at least one side surface of the mounted embedding cassette. The embedding tray is formed from a rubber material.

U.S. Pat. No. 5,424,040 A explains a surgical pathological specimen kit with cassette. The kit includes a surgical cassette for receiving a pathological specimen, a conical guide for guiding the specimen into the cassette, a cylindrical container to house the cassette and conical guide, and a lid to close the cylindrical container and seal the cassette and conical guide from the exterior. The cassette has a permeable concave membrane which eliminates mechanical handling and increases specimen yield for microscopic examination. A bar code tracking or audit system is used to facilitate identification, tracking and storage of specimens and cassettes.

EP 0 471 534 A2 is directed to a stackable cassette and apparatus for preparation of multiple specimens for histological examination. The cassettes include a bottom wall, two side walls, a front wall and a back wall which define a cavity. The bottom wall has a plurality of apertures disposed therein for passage of fluid through the cassette in a direction orthogonal to the plane of the bottom wall. At least two walls selected from the back wall, two side walls and front wall have a plurality of apertures disposed therein for passage of fluid through the cassette in the direction parallel to the plane of the bottom wall. In one embodiment of the invention, the cassette further includes a web of porous material disposed over the apertures in the bottom wall and side walls. When the cassettes are placed in stacked relationship the bottom wall of an overlying cassette provides a cover for the underlying cassette.

U.S. Pat. No. 5,665,398 A is directed to a system for providing an embedded specimen subsequent to fluid treatment of the specimen and preparatory to histological examination. The system includes the combination of a cassette for use in the preparation of specimen specimens for histological examination and an embedding mold having a first cavity for receiving the treated specimen and a second cavity for receiving the cassette. The system includes means for dispensing a predetermined amount of molten wax into the embedding mold.

U.S. Pat. No. 6,017,476 A describes a specimen processing method and cassette utilizes an open-topped, perforated collection cradle and a flat, perforated embedding pedestal which snap together in a male/female relationship to enclose and orient a specimen during chemical processing. After chemical processing, the embedding pedestal enables a specimen to be embedded in exactly the same plane as the cutting plane of a microtome during sectioning. This minimizes the number of sections required for histologic evaluation and eliminates the need for mechanical handling of the specimen after its initial collection.

All of the above-mentioned publications are herewith incorporated by reference.

### SUMMARY

It is an object of the present invention to provide a better and/or alternative method for handing at least one or more specimen(s), such as tissue specimen(s), preferably to submit the specimen(s) and data related to the specimen(s) reliably.

This object is attained with the subject matter according to the respective claims.

The present invention relates to a method of or for handling at least one pathologic specimen. In the present context, pathology specimen can comprise histology specimen or histology specimens that can further derive from livestock farming, veterinary, scientific laboratory, botanic, agricultural, forestry, maritime or other entities. Clinical studies can require an efficient handling, that can further be an automated handling.

Such a specimen can be any specimen being the result of a pathologic examination and also embraces biopsies samples and/or liquid biopsies. The method can comprise the steps of: providing at least one container for the specimen, transferring at least one specimen into the container, and capturing a first data set in a first station. These method steps can be performed in any order. This comprises also the performance in different places or the simultaneous performance of at least two or all of these steps.

The further step can be a generating of a transfer sheet with accumulated data on the basis of at least the first data set. Other data, such as contained in pre-prepared data, templates and/or provided or introduced in other stations or the same station can also be accumulated in the transfer sheet.

The method can also comprise the delivering of the container with the specimen and the transfer sheet to a further pathologic preparing and/or analyzing stage. Such stage can be remote or in the same or neighboring place of the deposition of the specimen. It can be usually remote of the place where the specimen has been taken from a patient. It can be further common that such stages are specialized laboratories analyzing in large scale and preferably providing reports to doctors having taken the specimen from the patients.

The method according to the present invention can also comprise the steps of capturing a container related ID data set and the accumulating of the first data set and the ID data set and with the further step of generating the transfer sheet on the basis of the accumulated data. The ID data can be attached to the container and can be linked to the container during its lifetime and even to the later specimen or parts thereof being deposited in a specimen storage for documentation purposes. The ID data can be linked to a container and, thus, if wanted, also to a place or a doctor where the container has been tracked. In this manner, the origin and the handling process of the specimen can be further documented. This is optional only.

The ID data set can be prior and fixedly attached to the container, preferably in machine-readable and/or human readable form, more preferably in bar code form, and even more preferably in QR-code form. According to a further step a scanning of the ID data set and then accumulating the first data set and the ID data set can take place. In this manner the ID data set of the container can be linked to the data set related to the specimen and potentially to their information. In particular, a data set can be encrypted and/or can comprise numerical, alphabetical, alphanumerical and other data or combinations thereof.

The present invention can further comprise the step of submitting the ID data set to a web form where it is accumulated with the other data sets. The web form can be a template run on a close server or on a remote server or in the so-called cloud. It can be the communication tool for a user to implement the data necessary and/or optional for the handling of the pathological specimen. The core idea can be to capture the information and not to store it locally or remotely but for just for capturing the data for the transfer sheet that can accompany the pathological specimen or probe in the container.

According to the invention there can be the further step of providing ID data set or positioned on the bottom of the container indirectly, preferably in form of a sticker, or directly, such as by printing. The ID data set can primarily comprise a unique ID identifying the container so that a specific container later can be specifically assigned to a specimen.

Further, the step can be accomplished by a machine-writing device that can write the ID data set on a RFID tag and/or an NFC tag.

The present invention can further have the step of providing the container in a rack in a form so that ID data set, preferably at the bottom of the container, can be scanned, preferably by at least one of an open part and a transparent part of the rack. The ID data set can be located at any place but it can be scanned in case the rack is configured to allow the reading out of the ID when the container is still in place in the rack. In order to allow easy optical access to the container the bottom of the rack can be provided with a hole and/or a transparent material so that a scanner can read out the ID positioned at the bottom of the container.

The present invention can further comprise the steps of capturing a second data set in a second station and accumulating at least two of the first data set, the ID data set and the second data set in accumulated data and generating the transfer sheet on the basis of the accumulated data. This can constitute one embodiment wherein the accumulated data or all or at least part of the data on the transfer sheet can be introduced on different or remote terminals or locations. Thus, a number of users can introduce different data sets that can be used on the transfer sheet.

The present invention can comprise the further step of submitting to and accumulating in at least two of the first data set, the ID data set and the second data set a first database (LIS) and submitting the accumulated data via an application program interface (API) to generate the transfer sheet, preferably via a web form. The database can only or just be used to generate the transfer sheet and not to store the data which is not legitimate in some of the jurisdictions. This can be one of a number of advantages on the one hand side to use the assistance of IT to capture and accumulate data and on the other hand side not to store it so that a misuse of the data can be excluded. The web form has been further explained before.

The ID data set can comprise at least one of an ID of the container, batch information, its intended use. These can be contained individually, in groups or all together. Other information can also be contained.

The generating of the transfer sheet can comprise compiling the accumulated data sets in a matrix code form, a bar code form, preferably printing the QR-code onto the transfer sheet. The compiling is intended to transfer the information into the code form or at least the essential information therefor. Also, other information carriers can be used, such as semiconductor media, NFC media, RFID media, Bluetooth or USB-readable media etc.

The present invention can also have the step of providing a package, preferably a specially adapted package for the container or a rack of containers and the respective transfer sheet(s) and introducing the container or the rack and the transfer sheet(s) into the package for the delivery. The package can be specifically adapted to ensure safe and common transport of the container and the transfer media. It can comprise one or more compartments for both or each of the container and the transfer sheet. They can also be combined and a pocket can be provided onto the transfer sheet for allowing the insertion of the container. Such pocket or the package can be sealed in order to provide a tamper evident transport.

The present invention can further have the step of reading out at least part of the accumulated data, preferably the QR-code, of the transfer sheet that is relevant for the further handling, preparing and/or analyzing stage, after the delivering of the container with the specimen and the transfer sheet to a further preparing and/or analyzing stage.

The present invention can be provided with the further step after the delivering of the container with the specimen and the transfer sheet to a further preparing and/or analyzing stage of reading out at least part of the accumulated data of the transfer sheet to a second database (LIS) being remote to the first laboratory information database (LIS). While the first database is being used to collect and/or transfer and/or accumulate the data without storing the data for data security reasons, the information can be fed into the second database and stored therein for documentation purposes.

The present invention can also have the first data set that comprises at least one of sample information, diagnostic information, the anatomic origin of the specimen and handling information, and the second data set comprises at least one of patient information and billing information. Any other data and considerably more voluminous data can also be contained.

The present invention can comprise the steps of transferring a single or a plurality of specimen into the container wherein the first data set further comprises at least one information about the number of specimen, the anatomic origin of the specimen and the kind of specimen. One of the examples are biopsy samples collected from the same anatomic part of a patient's body but from different portions thereof. The data can also comprise a schematic sketch or actual picture of that part with an identification of the part where the biopsy has been taken from.

The present invention can have the further step of assembling a plurality of containers, for instance in a rack or a bucket or a bag, and providing one or more respective transfer sheets for the rack and/or for the containers before delivering the container with the specimen and the transfer sheet to a further preparing and/or analyzing stage. The rack can have the advantage of a more efficient transport of packages of more appropriate sizes.

The present invention can have the further step of providing a plurality of containers in a rack in a laboratory or by the sending entity before initial use and with the further step of indexing the rack to an unloading position, reading a rack ID data set and submitting the rack ID data set via an application program interface (API) to at least one of a database or preferably to a web form. The API can be used for just or only transferring the respective information to a web form that in turn is being used for assembling or aggregating or accumulating the information to the transfer sheet. The information may be conveyed to an API and from there to a LIS or directly to a LIS.

The present invention can also comprise a support for a rack and for indexing the rack and/or the containers before initial use and for scanning and submitting the ID data set of at least each container to a first laboratory database (LIS). Like in the delivery of the containers with the specimen the provision of the containers before the initial use can be provided in rack form. This can have transport and handling and storing efficiency reasons.

The present invention is also directed to a transfer sheet with accumulated data generated according to any one of the steps described or claimed before and/or below.

The present invention can also be directed to a use of a method according to any one of the preceding or below method steps for the analysis of pathological specimen, particularly for the analysis of pathological biopsies.

The present invention can provide a number of advantages. It can ensure a simple and safe transmittal of specimen(s) with the respective data in a secure form and nevertheless making an automated or fully automated handling process possible. Several jurisdictions requiring the omission of initial data storage and/or of data transmission via any network, such as the internet, can be fulfilled at the same time.

### DESCRIPTION OF VARIOUS EMBODIMENTS

In the following, exemplary embodiments of the invention will be described, referring to the figures. These examples are provided to provide further understanding of the invention, without limiting its scope.

In the following description, a series of features and/or steps are described. The skilled person will appreciate that unless required by the context, the order of features and steps is not critical for the resulting configuration and its effect. Further, it will be apparent to the skilled person that irrespective of the order of features and steps, the presence or absence of time delay between steps, can be present between some or all of the described steps. Any features described and claimed in connection with the device claims are also applicable to the method claims and to be understood as respective method steps and vice versa.

The term “and/or” intends to embrace each alternative alone or any kind of combination of the alternatives listed. An “and/or” before the last member of a list of alternatives is to be understood to as being in-between each of the members of the list.

As used herein, including in the claims, singular forms of terms are to be construed as also including the plural form and vice versa, unless the context indicates otherwise. Thus, it should be noted that as used herein, the singular forms “a”, “an” and “the” include plural references unless the context clearly dictates otherwise.

Throughout the description and claims, the terms “comprise”, “including”, “having”, and “contain” and their variations should be understood as meaning “including but not limited to” and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

The same reference numerals used for different embodiments are intended to identify parts or features of different embodiments with the same or similar function. In case the same reference numerals are not identified in other embodiments, this is by no means intended to mean that the corresponding features designated by these reference numerals are not present.

The expression “specimen” comprises for instance human and/or animal specimen. The words “specimen” and “specimens” are used interchangeably and have the identical meaning, unless specifically distinguished the singular or the plural form.

The word “pathology” and its derivates shall be understood interchangeably with “histology” and its derivates.

The expression “web form” can be any template or similar user interface for automatically or semi-automatically capturing, feeding in and/or generating data to prepare and/or print a transfer sheet. The web form can be uploaded into a station via any network such as the internet, the local network etc.

The expression “rack” shall also comprise at least one bag, a bucket or any other bundle of individual sample containers.

### DRAWINGS

FIG. 1 shows an example of a container for the handling of pathologic specimen according to the present invention;

FIG. 2 exemplifies a bottom view onto a container for the handling of pathologic specimen according to the present invention;

FIG. 3 exemplifies a preferred scheme of a method for handling pathologic samples according to the present invention and

FIG. 4 depicts an embodiment of a method for handling pathologic samples according to the present invention.

### BRIEF DESCRIPTIONS OF THE DRAWINGS

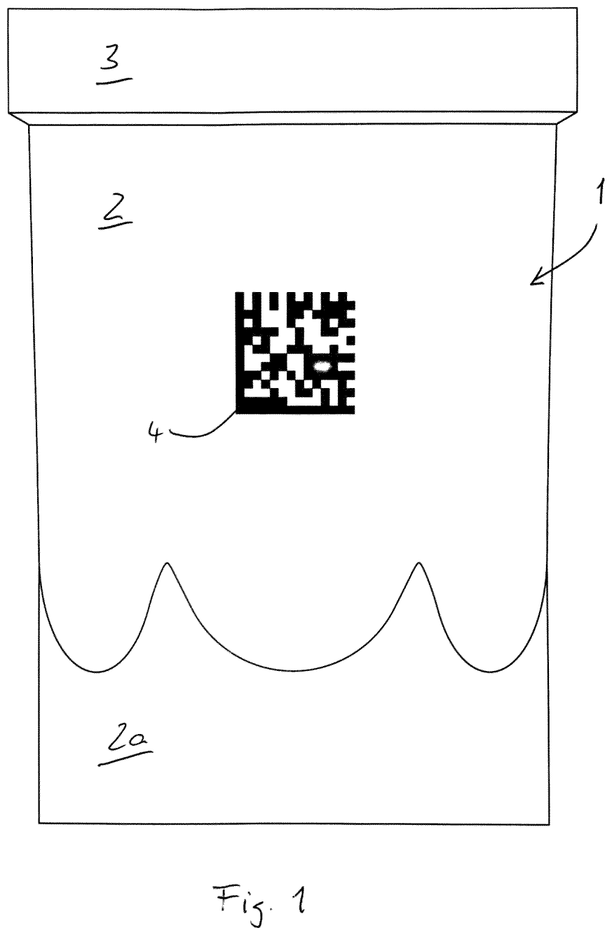

FIG. 1 displays part of a container 1 in accordance with an aspect of the present invention and as described above. The container can have many shapes such as brick stone shaped or cylindrical as shown. It can comprise a cassette (not shown) as it is generally used in the art. One or more cavity/cavities (not shown) can be provided in the container. The cavities can be formed by respectively shaped side walls and/or a bottom. A separation wall can keep the contained samples apart.

The cassette in the container 1 can have a box-shape or a cylindrical shape that inter alia can be used for labelling the cassette or the whole container assembly. The base of the cassette can be generally perforated with a grid in order to allow liquid to penetrate there through. The grid an extend over the whole bottom of the cassette or just a part thereof.

The container 1 can be opened by a lid 3 that can be attached to a remaining container body 2 in any form. In the embodiment shown the lid 3 can be screwed onto the remaining container body 2. The specimen can be introduced into the container 1 by opening the lid 3 and putting the specimen (not shown) in the container body 2 with an or to an already existing liquid, such as formalin.

A bottom 2a of the container body 2 can have a different shape as is sketched in the embodiment shown. Anyhow, it can have any shape and also the same shape as the body of the container.

In FIG. 1 a container ID data set 4 is shown, in the embodiment depicted in QR-code form. It can be of any other form such as human-readable or machine-readable codes. The ID data set 4 can be printed on the container 1 directly or printed on a sticker that is then attached or sticked onto the container.

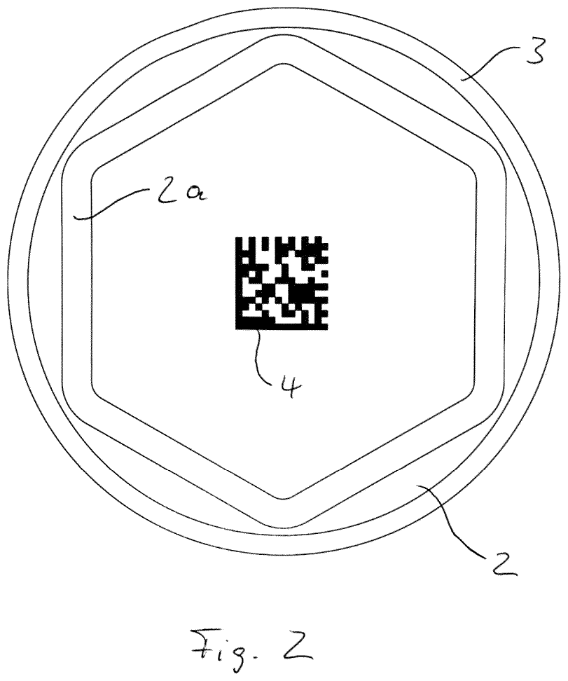

FIG. 2 represents another embodiment of the container 1 and the placement of the ID data set 4 onto the bottom 2a of the container body 2. In this figure also the lid 3, the container body 2 as well as the container body bottom 2a are shown. The perspective is from the bottom side or from the bottom of FIG. 1.

This embodiment can provide the advantage that in case the container 1 is placed in a rack (not shown) together with other containers (not shown), the ID data set 4 of each container can be read out from the bottom and a respective window or transparent part (both not shown) of the rack. The respectively read out ID data set 4 can then be assigned to a respective container at that position in the rack.

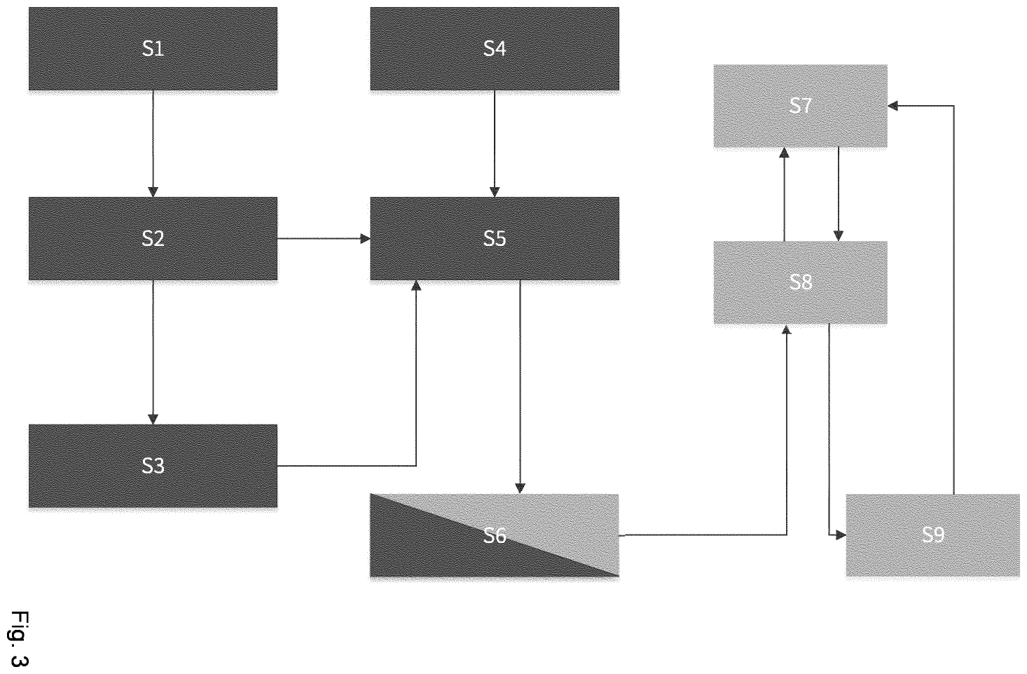

FIG. 3 depicts one example of a method in accordance with the present invention. In a step S2 a first data set can be captured. This first data set can be the sample information or specimen information, the diagnostic information, the anatomic origin of the specimen or a biopsy sample by description, sketching etc., the handling information about the steps to be performed when analyzing the specimen, etc.

Another data set can be already provided or captured in step S1, as an example a second data set. This data set can be provided by another station or being captured from a database. The second data set can comprise patient related data, such as patient ID information, patient parameters, billing information, hazard information etc.

There are now depicted two potential routes of further data processing or handling. One is directly to step S5 that can be an online application or software that is called web form for the sake of brevity. This web form is able to capture either semi-automatically or automatically the data to be accumulated and to transmit it to a transfer sheet generated in step S6. The capturing in automatic fashion can mean a pulling process of all data sets by the web form in step S5. Semi-automatic can mean that the web form in step S5 is initiated and controlled by a user.

The alternative or additional route is via step S3 that can be a first database capturing the first and potentially also the second data sets and provide it via an API to the web form in step S5. In this case the first database has the function to accumulate and push the data from the upstream data sets. The first data base may also be an insurance card on which personal and/or accounting data can be stored and further can comprise specific health data.

In a step S4 the ID data set assigned to the container is provided and read out and fed to step S5. The reading out can be done by a user and preferably by a scanning of a machine-readable code, such as a QR-code. The ID data set is then joined in step S5 by the web form to the first and potentially second data sets and accumulated therewith. The ID data set can alternatively also be fed into the second data set in step S1, into the first data set in step S2 or sequentially or parallel thereto and then accumulated in step S3 and further processed.

In step S5 the transfer sheet is prepared that is provided in step S6 by printing, labeling the container etc. In step S5 a QR-code can be generated that accumulates the data sets fed in or at least relevant parts thereof. This QR-code can then be printed onto the transfer sheet to make the transfer sheet machine-readable. Alternatively, or additionally a text can be provided in step S6 and in the respectively generated transfer sheet. The transfer sheet can be any paper document or other media to transmit the accumulated data together with, in connection to or in conjunction with the container when being sent out or shipped. A special package (not shown) to join the container and the transfer sheet can also be provided as described before. Also, the containers can be shipped individually or in rack form with the respective transfer sheets.

In step S8 a device or assembly of devices can derive the specimen from the container and the data from the transfer sheet in semi-automated or fully automated manner. It can also derive any pictures etc. from the accumulated data on the transfer sheet or aside the transfer sheet.

In step S7 the accumulated data from the transfer sheet can also be extracted or scanned and fed into a second database remote from the first database. In the second database the data or at least parts thereof can be stored. The internet-based transmittal of the accumulated data can, thus, be avoided and requirements in several jurisdictions can be met while still ensuring a quick and safe procession of the data.

The data can be transmitted from the transfer sheet according to step S6 to step S7 either directly or via step S8. In step S7 also marking can be re-fed into step S8, particularly when the pathological preparation and/or storing by a cassette is done in order provide the respective data onto the cassette either directly or by a sticker or by any other media, such as an RFID or NFC medium.

In step S9 a pathologist can also interact with the steps S7 and S8. The pathologist can derive data and information and can feed it back in step S8, i.e. into the second database. Also, pictures and videos can be displayed to the pathologist in step S9 that have been gathered in the lab and transmitted, such as pictures of the anatomic origin of the specimen of a patient. The unpacking and/or preparation can be done automatically and/or independently in step S8.

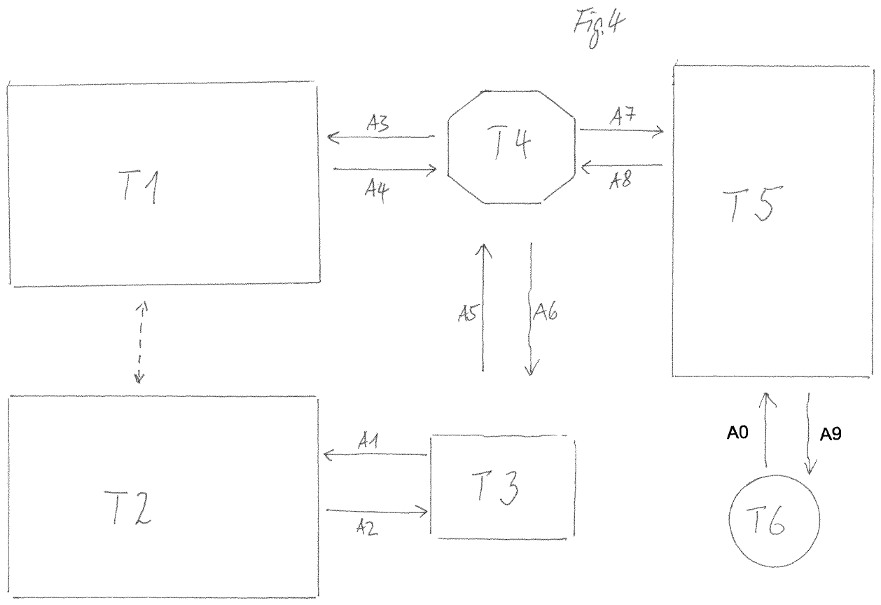

FIG. 4 depicts an embodiment of a method in accordance with the present invention. The practitioner at party T2 prepares a histological specimen that has to be examined; further to the specimen itself s/he also can take a picture or a drawing, a video or a thorough description. T3, for the sake of brevity called a “transfer-sheet” requests further responses via channel A1 from the party T2 that T2 can convey to T3 via channel A2. Channels A1 and A2 can be a questionnaire, either on paper, via a dialog system like an IT-system and/or a submission of a diagnosis apparatus located at party T2.

Once all required data collected by transfer-sheet T3, a web-based application T4 receives the information conveyed by T3 via channel A5. Per back channel A6 the transfer-sheet T3 receives a status message via A6, that can comprise an acknowledgement or a fault message. The web-application or database T4 can request from IT-system T1 via channel A3 information about patient data, client data, billing data and/or further data that may be needed for further processing a sample or specimen. Channel A4 can be used to convey the requested information to the web-application T4 and further can transfer hazard information or further important, not requested information either in a formalized method or as a free text or code.

As soon as T4 has all relevant data from T1, T2 and T3, a set of data may be produced, stored and/or forwarded that can be written to a writable media along with the container with the specimen or with a cassette housing the specimen. Further to an electronically message written onto an electronically writable media like a RFID or an NFC tag, that can be of a type write once/read multiply. This method can grant a tamper proof method to allocate information to a specimen. Further, write multiply/read multiply RFID or NFC media can be used in case if data protection and privacy concerns are less relevant.

Also, a laser, an ink-jet and/or a human can write coded or plain data onto a cassette or on a sticker in a human and/or machine-readable form. Such information can, for instance, comprise a code under which the full, readable information can be retrieved from the web-application T4 and/or a laboratory information system (LIS) T5 and further to the originating party T2 or to the database associated with database T1.

LIS T5 can be adapted to communicate with the examining site T6 via channels A9 and A0 which can be a pathologist, a person specialized in histological examination, an automated apparatus that examines or compiles the diagnostic information or a combination thereof.

A0 is meant to represent the diagnosis of the specialist or a specific apparatus, who/which can access most if not all of the data in the method disclosed. A0 shall finally be transferred to party T2 and/or to database T1; further steps can be taken (and will usually be taken) by the initiating person at party T2.

T1 can be the database that is handled by the responsible party T2, such that the communication (represented by a dotted line) is self-explanatory. However, even T1 and T2 can be separated entities, wherein the party at T2 doesn't need information from database T1 directly. This is one option, if privacy or data-protection rules prohibit transfer of sensual data.

It should be noted that all information channels A1 to A9 and A0 can either be an automated transfer of information via cable, wireless network, code-driven or a combination thereof, where only codes are transferred that allow the user to retrieve the human-readable information from a display or a printout in accordance with data-protection rules. It should be understood that all transfer of information (A1-A9 and A0) can be hand-written, machine-written, electronically written and even can comprise an orally conveyed information.

Where a data transfer is referenced to be done to a LIS, it should be understood that such a transfer may be accomplished via an integration server.

1-17. (canceled)

18. A method for handling a pathologic specimen, comprising:
providing a container for the pathologic specimen;
transferring the pathologic specimen into the container;
capturing a first data set at a first station;
generating a transfer sheet based on accumulated data comprising the first data set; and
delivering the container with the specimen and the transfer sheet to a pathological preparing and/or analyzing stage.

19. The method according to claim 18, further comprising capturing a container-related ID data set and accumulating the container-related data to the transfer sheet.

20. The method according to claim 19, wherein the ID data set is attached to the container, in machine-readable and/or human readable form,
further comprising scanning the ID data set and then accumulating the first data set and the ID data set.

21. The method according to claim 20, wherein the ID data set attached to the container comprises a bar code and/or a data-matrix code.

22. The method according to claim 21, further comprising submitting the ID data set to a web form where the accumulated data is generated to comprise the first data set and the ID data set.

23. The method according to claim 20, further comprising:
attaching the ID data set to a side and/or a bottom of the container; and/or
printing the ID data set on the side and/or the bottom of the container.

24. The method according to claim 20, further comprising capturing a second data set at a second station, wherein the accumulated data comprises the first data set and/or the ID data set and the second data set.

25. The method according to claim 24, further comprising submitting and accumulating two or more of the first data set, the ID data set and the second data set to a first database (LIS) and submitting the accumulated data via an application program interface (API) to the transfer sheet.

26. The method according to claim 24, wherein the first data set comprises sample information, diagnostic information, an anatomic origin of the specimen and/or handling information, and the second data set comprises patient information and/or billing information.

27. The method according to claim 26, wherein a plurality of specimen and/or a plurality of portions of the specimen are transferred into the container and the first data set further comprises information about the number of specimen, an anatomic origin of the specimen or a kind of the specimen.

28. The method according to claim 19, wherein the ID data set comprises an ID of the container, container-batch information, and/or an intended use of the container-batch.

29. The method according to claim 18, wherein the generating the transfer sheet comprises:
compiling the accumulated data set and conveying the accumulated data to a web-application, and/or
transferring the accumulated data in a matrix-data-code, a barcode, a QR-code, a RFID tag, and/or an NFC tag, and/or
issuing the accumulated data in machine and/or human readable form, and/or
generating and conveying an access-handle to the web-application.

30. The method according to claim 18, further comprising introducing the container or a rack comprising the container and the transfer sheet into a package for the delivering.

31. The method according to claim 18, wherein the delivering the container with the specimen and the transfer sheet to the further preparing and/or analyzing stage further comprises sending at least a portion of the accumulated data of the transfer sheet to a second database (LIS) remote from the first laboratory information database (LIS).

32. The method of claim 18, wherein the pathological preparing and/or analyzing stage is used for analysis of one or more tissues and/or pathological biopsies.

33. A device, comprising:
a rack configured to hold a plurality of containers; and
a support for the rack,
wherein the plurality of containers comprises at least one container with a specimen and a transfer sheet generated based on accumulated data comprising a first data set, captured at a first station before a pathological preparing and/or analyzing stage, and
wherein the rack and/or the plurality of containers are indexed before initial use of the rack and to scan and submit the ID data set of each of the plurality of containers to a first laboratory database (LIS).

34. A transfer sheet for a container used to hold a pathologic specimen, wherein the transfer sheet is generated based on accumulated data, comprising a first data set, captured when the container including the pathologic specimen is at a first station.
